(19) United States
(12) Patent Application Publication
(10) Pub. No.: US 2017/0246483 A1
(43) Pub. Date: Aug. 31, 2017

(54) EVACUATION RAMP

(71) Applicant: D.N.E., LLC, Slatington, PA (US)

(72) Inventor: Nicholas Riccione, Slatington, PA (US)

(21) Appl. No.: 15/444,557

(22) Filed: Feb. 28, 2017

Related U.S. Application Data
(60) Provisional application No. 62/301,264, filed on Feb. 29, 2016.

(51) Int. Cl. A62B 1/20

(52) U.S. Cl. CPC A62B 1/20

(57) ABSTRACT

An inflatable evacuation ramp for evacuating people from a building during an emergency situation may include an inflatable slide having a length at least long enough to extend from a window on a second floor of the building to the ground and a window attachment member coupled with one end of the slide, for attaching the slide to a window frame on the building. A method for evacuating a person from a building during an emergency situation may involve attaching one end of an inflatable slide to a window frame of the building, inflating the inflatable slide so that it extends from the window frame to ground near the building, and sliding the person down the slide to the ground.

### CROSS-REFERENCE TO RELATED APPLICATIONS

This application claims the benefit of U.S. Provisional Patent Application No. 62/301,264, filed Feb. 29, 2016, entitled, “EVACUATION RAMP.” The disclosure of this priority application is hereby incorporated by reference in its entirety into the present application.

### FIELD

This application describes an evacuation ramp. More specifically, the application describes an inflatable evacuation ramp for use in evacuating a building.

### BACKGROUND

Inflatable ramps for evacuating passengers from aircraft have long been known. Such ramps work well and are easy to store on an aircraft in a collapsed, uninflated configuration. Two examples of inflatable evacuation ramps are described in U.S. Pat. Nos. 3,845,920 and 3,712,417.

Evacuation of people, especially children, from buildings such as schools and homes can be very challenging. In some instances, fire fighters may provide a cushion or other padded device into which a person must jump from a window of a building. In other cases, where a building is equipped with evacuation ladders, a child fleeing the building will be required to exit the building feet first, facing the building wall, and climb down the ladder. This can be very difficult and scary for a child or even for many adults. Furthermore, such evacuation ladders are bulky and rarely available. At the present time, there are simply no optimal products or solutions for evacuating people, especially children, from a building. At the same time, building evacuations are becoming ever more important, as mass shootings occur more and more frequently at schools and other public buildings.

Thus, there is a need for improved building evacuation devices. Ideally, such devices would be relatively easy to manufacture, store and use in an emergency. Also ideally, such devices would be easy for children to use in evacuating a building and would be less intimidating and frightening than current evacuation alternatives. At least some of these objectives will be addressed by the embodiments described in this application.

### SUMMARY

In one aspect, an inflatable evacuation ramp for evacuating people from a building during an emergency situation may include an inflatable slide having a length at least long enough to extend from a window on a second floor of the building to the ground and a window attachment member coupled with one end of the slide, for attaching the slide to a window frame on the building. In some embodiments, the inflatable slide may include a flat slide body, having opposite edges and two guardrail portions, where each of the guardrail portions extends upwards from one of the opposite edges of the slide body. Optionally, the inflatable slide may further include at least one support member disposed along the slide body to help prevent the slide from collapsing while an evacuee is sliding down the ramp. In some embodiments, the inflatable slide further comprises a landing portion at an opposite end of the slide from the window attachment member for positioning on the ground.

In another aspect, a method for evacuating a person from a building during an emergency situation may involve attaching one end of an inflatable slide to a window frame of the building, inflating the inflatable slide so that it extends from the window frame to ground near the building, and sliding the person down the slide to the ground.

In some embodiments, the window frame is located on a window of a second story or higher of the building. Attaching one end of the slide to the window frame may involve attaching an attachment member coupled with the end of the slide to the window frame. Any building may evacuated using the ramps/slides described herein, such as but not limited to a house, a school building, an office building or a public building.

These and other aspects and embodiments are described in greater detail below, in reference to the attached drawing figures.

### BRIEF DESCRIPTION OF THE DRAWINGS

FIG. 1 is a perspective view of a house and an inflatable evacuation ramp, according to one embodiment;

FIG. 2 is a perspective view of a school building and an inflatable evacuation ramp, according to another embodiment; and

FIG. 3 is a perspective view of an inflatable evacuation ramp collapsed and packaged, according to one embodiment.

### DETAILED DESCRIPTION

Set forth below is a description of various embodiments of the invention claimed. Future and present alternatives and modifications to these embodiments are contemplated within the scope of the invention.

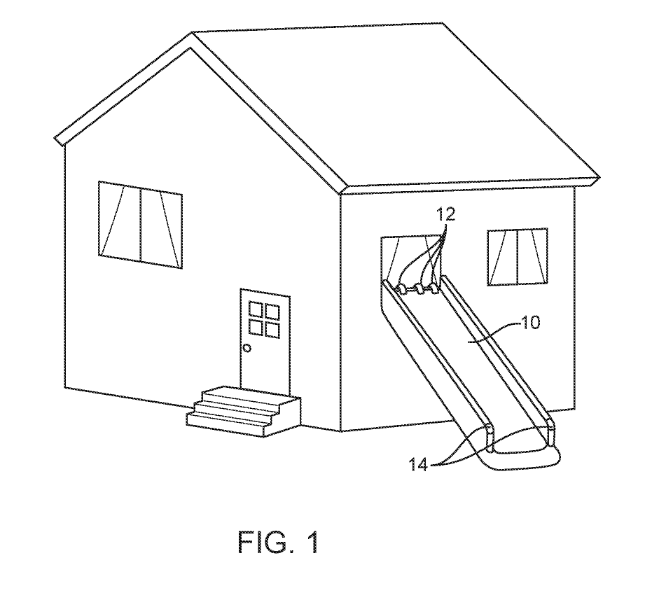

Referring to FIG. 1, one embodiment of an evacuation ramp 10 (or “slide”) for evacuating people from a house (as shown) or other building is illustrated. In this embodiment, ramp 10 includes a window attachment member 12 and two guardrails 14. Ramp 10 may be very similar or the same as any of a number of ramps used to evacuate aircraft. In some embodiments, the length, width, thickness, stiffness and/or other characteristics of ramp 10 may differ from those of an aircraft evacuation ramp, in order to accommodate evacuations from a building. The length of ramp 10, for example, will typically be long enough to reach from a window of a second story of a house or other building to the ground. In various embodiments, ramp 10 may have a length designed to extend from a third story, fourth story, fifth story, etc. of a building. In addition to the features shown, ramp 10 may also include one or more lateral and/or longitudinal support members, which may or may not be inflatable. Support members may help prevent ramp 10 from collapsing while a person is sliding down it to the ground. Any other suitable features, such as but not limited to those that have been described in aircraft evacuation ramps, may be incorporated into ramp 10.

Attachment member 12 may be multiple hooks, as shown, one wide hook, one or more clamps, a press fit attachment member, or any other suitable attachment structure for attaching to a window frame. Attachment member 12 may be attached to one end of ramp 10 via adhesive, stitching or any other suitable means. Guardrails 14 may be built into ramp 10, as shown, to help prevent an evacuee from falling off one side of ramp 10. Guardrails 14 may be inflatable, just as ramp 10 is, and they may extend vertically upward from opposite edges of the horizontal ramp body.

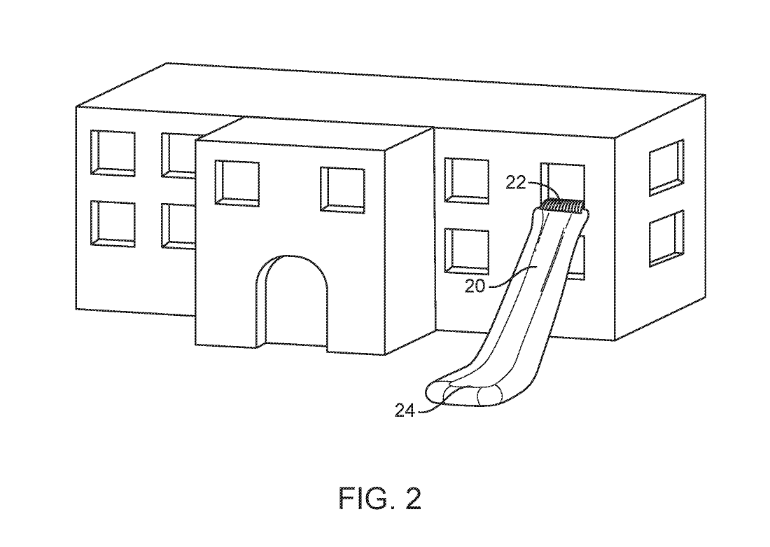

Referring now to FIG. 2, an alternative embodiment of an evacuation ramp 20 is illustrated, in this case for evacuating a school building. In this embodiment, ramp 20 includes a window frame attachment member 22 and a landing area 24. Landing area 24 is designed to lie flat on the ground, when ramp 20 is deployed, to provide a padded area for an evacuee to land on after sliding down ramp 20. Again, any other features may be incorporated into ramp 20, such as guardrails, support members or the like.

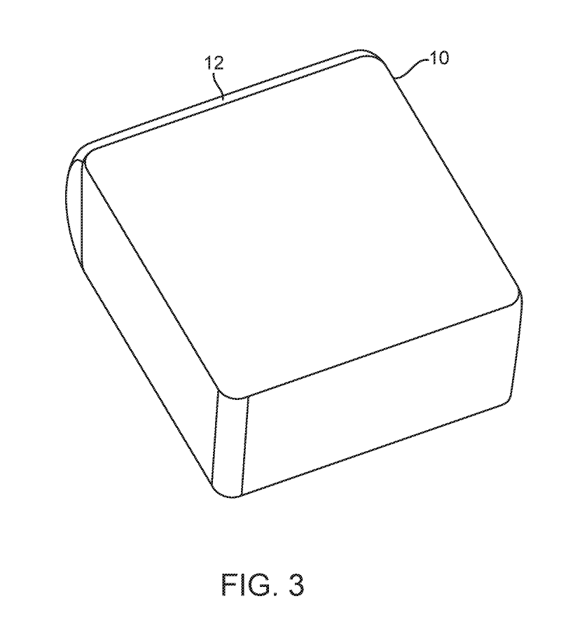

Referring to FIG. 3, ramp 10 and its attachment member 12 are illustrated in a collapsed, uninflated configuration. Ramp 10 and attachment member 12 may be wrapped in a plastic or other wrapping that is easy and quick to open in an emergency. One of the advantages of the ramp systems described herein is that they may be made very affordably and may be stored easily within a building, such as directly under window frames or in a small storage compartment near the windows. During a building evacuation, such as for a fire, a terrorist attack, a mass shooting, or any other emergency, one or more ramps 10 may be quickly retrieved from storage, any packaging or wrapping opened, attachment member 12 attached to a window frame, and ramp 10 inflated. Evacuees may then slide down ramp 10 to the ground to safety. Ramp 10 may be inflated by any suitable inflation mechanism, such as the automatic inflation devices used in aircraft evacuation ramps.

The evacuation ramps described herein may be used to evacuate any type of building and may be extremely beneficially, especially for evacuating children. Currently available evacuation mechanisms, such as ladders, are often not installed on buildings and can also be very scary especially for children to use. The inflatable ramps described here could be easily and inexpensively supplied for any building, to make evacuations quick, easy and safe.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims. Likewise, various changes, additions, omissions, and modifications can be made to the illustrated embodiments without departing from the spirit of the present invention.

I claim:

1. An inflatable evacuation ramp for evacuating people from a building during an emergency situation, the ramp comprising:
an inflatable slide having a length at least long enough to extend from a window on a second floor of the building to the ground; and
a window attachment member coupled with one end of the slide, for attaching the slide to a window frame on the building.

2. A ramp as in claim 1, wherein the inflatable slide comprises:
a flat slide body, having opposite edges; and
two guardrail portions, wherein each of the guardrail portions extends upwards from one of the opposite edges of the slide body.

3. A ramp as in claim 2, wherein the inflatable slide further comprises at least one support member disposed along the slide body to help prevent the slide from collapsing while an evacuee is sliding down the ramp.

4. A ramp as in claim 3, wherein the inflatable slide further comprises a landing portion at an opposite end of the slide from the window attachment member for positioning on the ground.

5. A method for evacuating a person from a building during an emergency situation, the method comprising:
attaching one end of an inflatable slide to a window frame of the building;
inflating the inflatable slide so that it extends from the window frame to ground near the building; and
sliding the person down the slide to the ground.

6. A method as in claim 5, wherein the window frame is located on a window of a second story or higher of the building.

7. A method as in claim 5, wherein attaching the one end of the slide to the window frame comprises attaching an attachment member coupled with the one end of the slide to the window frame.

8. A method as in claim 5, wherein the building is selected from the group consisting of a house, a school building, an office building and a public building.
